(19) United States
(12) Patent Application Publication
(10) Pub. No.: US 2004/0213346 A1
(43) Pub. Date: Oct. 28, 2004

(54) Moving image coding apparatus and method

(75) Inventors: Atsushi Matsumura, Kanagawa-ken (JP); Tomoya Kodama, Kanagawa-ken (JP); Noboru Yamaguchi, Saitama-ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/821,864

(22) Filed: Apr. 12, 2004

(30) Foreign Application Priority Data
Apr. 22, 2003 (JP) 2003-117293

(51) Int. Cl. H04N 7/12

(52) U.S. Cl. 375/240.03; 375/240.01

(57) ABSTRACT

A coding unit generates a code of each frame of a moving image. A first verification unit calculates a first code quantity predicted to be stored in a buffer if the code were to be supplied to the buffer in a virtual decoding apparatus by a first bit rate. A second verification unit calculates a second code quantity predicted to be stored in the buffer and a change rate of the second code quantity if the code were to be supplied to the buffer in the virtual decoding apparatus by a second bit rate lower than the first bit rate. A control unit changes a coding bit rate of said coding unit based on the first code quantity, the second code quantity, and the change rate.

### CROSS-REFERENCE TO RELATED APPLICATIONS

This application is based upon and claims the benefit of priority from prior Japanese Patent Application P2003-117293, filed on Apr. 22, 2003; the entire contents of which are incorporated herein by reference.

### FIELD OF THE INVENTION

The present invention relates to a moving image coding apparatus and a method for coding a moving image by changing a bit rate in real time.

### BACKGROUND OF THE INVENTION

As a method for coding a dynamic image by variable bit rate, for example, MPEG-1 (Moving Picture Expert Group phase-1), MPEG-2 and MPEG-4 exist. In MPEG (MPEG-1, MPEG-2, MPEG-4), entropy-coding is used, and a code quantity necessary for obtaining an image quality changes in proportion to a resolution and a motion degree of input moving image. By adopting a coding of variable bit rate and changing the bit rate based on characteristics of the moving image, the code quantity can be reduced in comparison with coding by fixed bit rate.

In the prior art, as a method for coding by variable bit rate, a coding method by two-pass variable bit rate and a coding method by multi-pass variable bit rate each for coding by variable bit rate based on characteristics exist (For example, Japanese Patent Disclosure (Kokai) 2003-18603).

In the coding method by two-pass variable bit rate and the coding method by multi-pass variable bit rate, various coding information such as coding difficulty degree, generated code quantity and frame skip is detected. Assignment code quantity of each scene is calculated using the detected coding information. Then, the coding processing is executed based on the assignment code quantity.

In the above reference (2003-18603), a statistical quantity including the code quantity is calculated by coding each frame using the fixed bit rate during the first pass. An assignment of code quantity and a quantization scale of each frame are then determined based on the statistical quantity during the second pass, and actual coding is executed by taking into consideration whether each frame includes a frame skip. In these coding methods, preprocessing is necessary during the first pass before actual coding, and the coding can not be executed in real time.

On the other hand, in a method of one-pass variable bit rate, an assignment code quantity of a scene to be coded next is calculated based on the coding result of a previous scene (For example, Japanese Patent Disclosure (Kokai) 2001-69463).

In the method of one-pass variable bit rate, coding can be executed in real time. However, in comparison with the coding method by two-pass variable bit rate, the image quality falls because of difficulty of prediction, and efficient assignment of the code quantity is difficult.

For example, in above reference (2001-69463), in the case that difficulty of coding is within a predetermined range, for example, coding of the fixed bit rate is executed by a bit rate lower than a target bit rate as ten percent. A surplus of code quantity generated is assigned to a following scene of which coding is difficult.

However, as for a scene of which coding difficulty is within a predetermined range, if the scene is coded by the fixed bit rate lower than the target bit rate uniformly, adequate code quantity can not be assigned to each scene. Concretely, the image quality is unnecessarily good for a scene of easy coding while the image quality is poor for a scene of difficult coding.

### SUMMARY OF THE INVENTION

The present invention is directing to a moving image coding apparatus and a method for raising quality of a scene of strict coding while keeping quality of a scene of easy coding as a necessary and sufficient condition.

According to an aspect of the present invention, there is provided an apparatus for coding a moving image, comprising: a coding unit configured to generate a code each frame of the moving image; a first verification unit configured to calculate a first code quantity predicted to be stored in a buffer if the code were to be supplied to the buffer in a virtual (i.e., predicted) decoding apparatus by a first bit rate; a second verification unit configured to calculate a second code quantity predicted to be stored in the buffer and a change rate of the second code quantity if the code were to be supplied to the buffer in the virtual decoding apparatus by a second bit rate lower than the first bit rate; and a control unit configured to change a coding bit rate of said coding unit based on the first code quantity, the second code quantity, and the change rate.

According to another aspect of the present invention, there is also provided a method for coding a moving image, comprising: generating a code of each frame of the moving image; calculating a first code quantity predicted to be stored in a buffer if the code were to be supplied to the buffer in a virtual decoding apparatus by a first bit rate; calculating a second code quantity predicted to be stored in the buffer and a change rate of the second code quantity if the code were to be supplied to the buffer in the virtual decoding apparatus by a second bit rate lower than the first bit rate; and changing a coding bit rate of the code generation based on the first code quantity, the second code quantity, and the change rate.

According to still another aspect of the present invention, there is also provided a computer program product, comprising: a computer readable program code embodied in said product for causing a computer to code a moving image, said computer readable program code comprising: a first program code to generate a code of each frame of the moving image; a second program code to calculate a first code quantity predicted to be stored in a buffer if the code were to be supplied to the buffer in a virtual decoding apparatus by a first bit rate; a third program code to calculate a second code quantity predicted to be stored in the buffer and a change rate of the second code quantity if the code were to be supplied to the buffer in the virtual decoding apparatus by a second bit rate lower than the first bit rate; and a fourth program code to change a coding bit rate of the code generation based on the first code quantity, the second code quantity, and the change rate.

### BRIEF DESCRIPTION OF THE DRAWINGS

FIG. 1 is a block diagram of a moving image coding apparatus according to a first embodiment.

FIG. 2 is a block diagram of a coding unit 101 of the moving image coding apparatus in FIG. 1.

FIGS. 3A and 3B are block diagrams of a VBV 102 and a virtual VBV 103 of the moving image coding apparatus in FIG. 1.

FIGS. 4A and 4B are schematic diagrams of occupancy of the VBV in the case of overflow and underflow according to the present invention.

FIGS. 5A and 5B are schematic diagrams of occupancy of the virtual VBV in the case of underflow and overflow according to the present invention.

FIG. 6 is a flow chart of processing of control of a quantization scale according to the present invention.

FIGS. 7A and 7B are schematic diagrams of occupancy of the virtual VBV in the case of under flow and overflow are gradually removed.

### DETAILED DESCRIPTION OF THE EMBODIMENTS

Hereinafter, various embodiments of the present invention will be explained by referring to the drawings.

In the image moving coding apparatus of the present invention, the moving image is coded by one-pass variable bit rate of MPEG-4. Especially, this apparatus is suitable for generating moving image data recorded in a store media from which data of variable bit rate is readable such as DVD (Digital Versatile Disc).

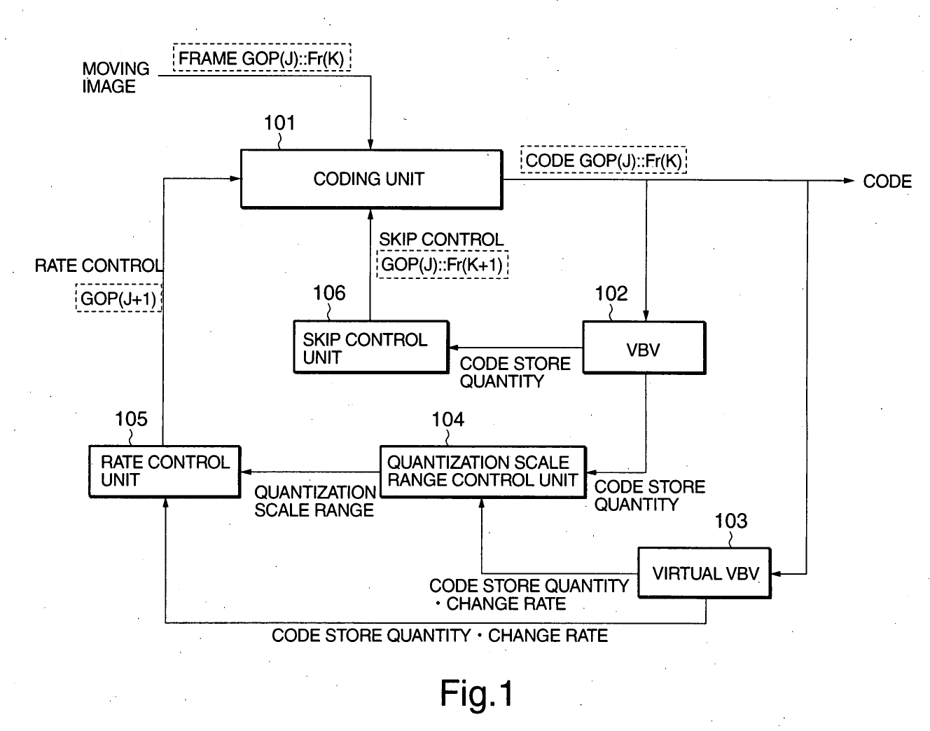

FIG. 1 is a block diagram of the moving image coding apparatus of the present invention. In the present embodiment, a coding unit 101 generates a code of MPEG-4 by variable bit rate from the moving image signal input from outside. A VBV (Video Buffer Verifier) 102 calculates a code quantity to be stored by a first input bit rate in a buffer (a virtual input buffer) of a virtual decoding apparatus based on the code quantity generated from the coding unit 101. A virtual VBV 103 calculates a code quantity to be stored by a second input bit rate in the buffer (the virtual input buffer) of the virtual decoding apparatus based on the code quantity generated from the coding unit 101, and calculates a change rate of the code quantity. A quantization scale range control unit 104 sets an upper limit value and a lower limit value of a quantization scale Qp of the coding unit 101 based on the code quantity calculated by the VBV 102 and the code quantity and the change rate calculated by the virtual VBV 103. A rate control unit 105 controls the coding bit rate of the coding unit 101. A skip control unit 106 controls a frame skip. The upper limit and the lower limit of the quantization scale Qp are set within a range of the maximum value and the minimum value of the quantization scale (For example, in MPEG-4, the maximum value is 31 and the minimum value is 1)

As used herein, those skilled in the art will understand that the term “unit” is broadly defined as a processing device (such as a server, a computer, a microprocessor, a microcontroller, a specifically programmed logic circuit, an application specific integrated circuit, a discrete circuit, etc.) that provides the described communication and the functional desired communication. While such a hardware-based implementation is clearly described and contemplated,.those skilled in the art will quickly recognize that a “unit” may alternatively be implemented as a software module that works in combination with such a processing device.

Depending on the implementation constraints, a software module or a processing device may be used to implement more than one “unit” as disclosed and described herein. Those skilled in the art will be familiar with particular and conventional hardware suitable for use when implementing an embodiment of the present invention with a computer or other processing device. Likewise, those skilled in the art will be familiar with the availability of different kinds of software and programming approaches suitable for implementing one or more “units” as one or more software modules.

Next, operation of the moving image coding apparatus is explained by referring to FIG. 1. In order to simplify the explanation, the case of not using a bidirectional prediction coding is explained as an example.

First, the moving image of each frame is input. In the case of MPEG-4, each frame belongs to a group of frames (It is called GOP (Group of Picture)). Accordingly, the K-th frame in the J-th GOP is represented as “GOP (J)::Fr(K)”. When a frame GOP (J)::Fr(K) is input, the coding unit 101 outputs a code GOP(J)::Fr(K). The VBV 102 and the virtual VBV 103 counts the code quantity of code GOP (J)::Fr(K), and respectively changes the code quantity of the virtual input buffer. The skip control unit 106 monitors the virtual input buffer of the VBV 102, and controls the coding unit 101 to skip coding of next frame GOP (J)::Fr(K+1) for the present frame GOP (J)::Fr(K) if a possibility of underflow is high. The quantization scale range control unit 104 determines a range of the quantization scale based on the code quantity of the virtual input buffer of the VBV 102 and the code quantity and the change rate of the virtual input buffer of the virtual VBV 103. The rate control unit 105 determines the coding bit rate of next GOP (J+1) for GOP (J) including the frame GOP (J)::Fr(K) based on the range of the quantization scale determined by the code quantity and the change rate of the virtual input buffer of the virtual VBV 103. The coding unit 101 executes coding of GOP (J+1) based on the coding bit rate determined by the rate control unit 105.

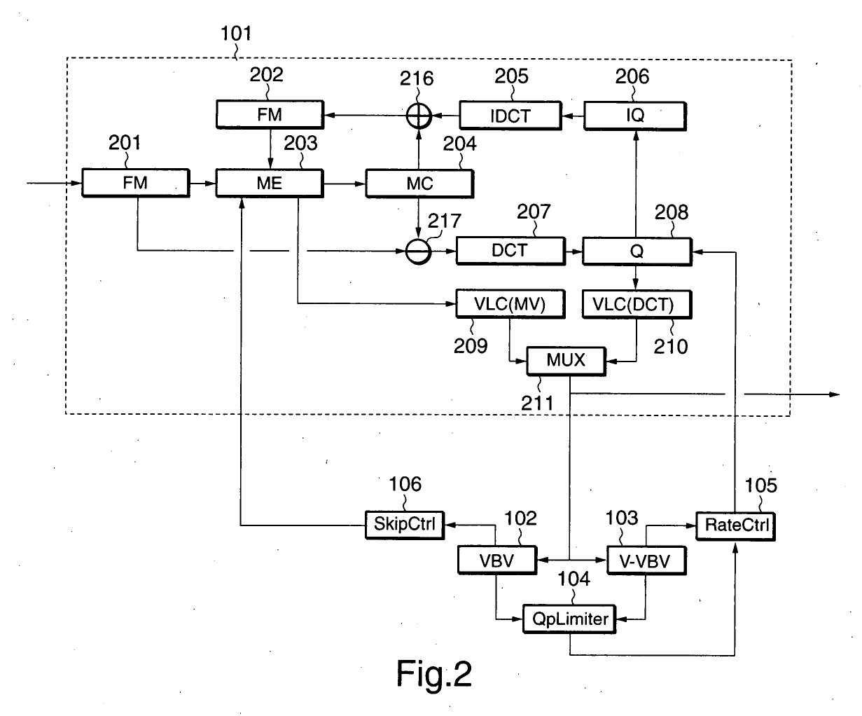

The coding unit 101 codes the moving image by MPEG-4 method. FIG. 2 is a block diagram of the coding unit 101. The coding unit 101 includes a frame memory 201 storing the input moving image in order, a frame memory 202 storing a reference frame used for motion detection, a motion detector 203 detecting a motion vector, a motion compensator 204 executing a motion compensation, and a subtractor 217 calculating a difference between a motion compensated frame and a coding object frame. Furthermore, the coding unit 101 includes a discrete cosine transform unit 207 executing discrete cosine transformation (DCT), a quantizer 208 executing quantization, an inverse quantizer 206 executing inverse quantization, an inverse discrete cosine transform unit 205 executing inverse cosine transformation (IDCT), an adder 216 adding the motion compensated frame to the inverse discrete cosine transformed frame, a motion vector variable length coder 209, a variable length coder 210 for DCT coefficient, and a bit stream multiplexer 211.

The motion detector 203 executes a frame skip in response to a frame skip control signal from outside, and does not code the frame. The quantizer 208 quantizes using a parameter representing quantization level such as quantization scale (Qp) supplied from outside. In the case of MPEG-4, the minimum value is 1 and the maximum value is 31 for the quantization scale Qp. In the quantization scale Qp, if a value of the scale becomes large, the quantization is rough and the image quality falls while the code quantity reduces. On the other hand, if a value of the scale becomes small, the quantization is fine and the image quality rises while the code quantity increases.

If the code generated by the coding unit 101 is input to the virtual decoding apparatus by the highest bit rate (peak bit rate), the VBV 102 calculates code quantity predicted to be stored in the input buffer (virtual input buffer) of the virtual decoding apparatus. In a general decoding apparatus, the code supplied by some bit rate is temporally stored in the input buffer. The decoding is executed using the code stored in the input buffer every predetermined time (For example, 1/30 second). The code quantity stored in the input buffer changes as follows.

(w) The code quantity increases in a predetermined time based on an input bit rate degree.

(x) The code quantity decreases as a quantity used for decoding processing every predetermined time.

(Y) Hereafter, (w) and (X) are repeated.

The VBV 102 preferably does not actually execute decoding (Of course, the VBV 102 must actually execute decoding. However, it is not currently practical), and preferably does not actually execute buffering (Of course, the VBV 102 must actually execute buffering. However, it is not currently practical). The VBV 102 calculates time transition of code quantity to be stored in the virtual input buffer.

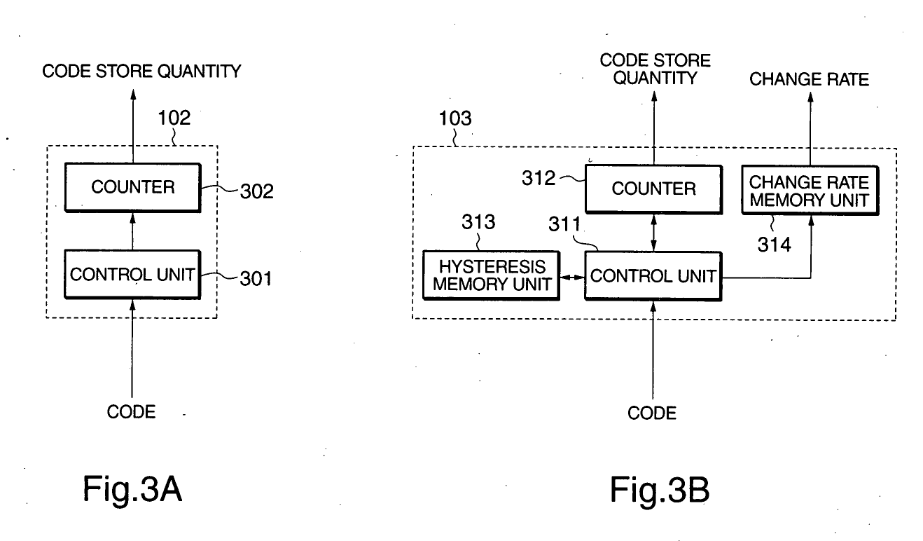

FIG. 3A is a block diagram of the VBV 102 according to the present embodiment. The VBV 102 includes a counter 302 storing code quantity to be stored in the virtual input buffer, and a control unit 301 increasing or decreasing a counted value of the counter 302. The code quantity stored in the input buffer of the VBV 102 changes as follows.

(1) The code quantity increases in a predetermined time by a speed of a peak rate degree.

(2) The code quantity decreases as a quantity to be used for decoding processing every predetermined time.

(3) Hereafter, (1) and (2) are repeated.

As the quantity to be used for decoding processing, code quantity generated for each frame by the coding unit 101 is used.

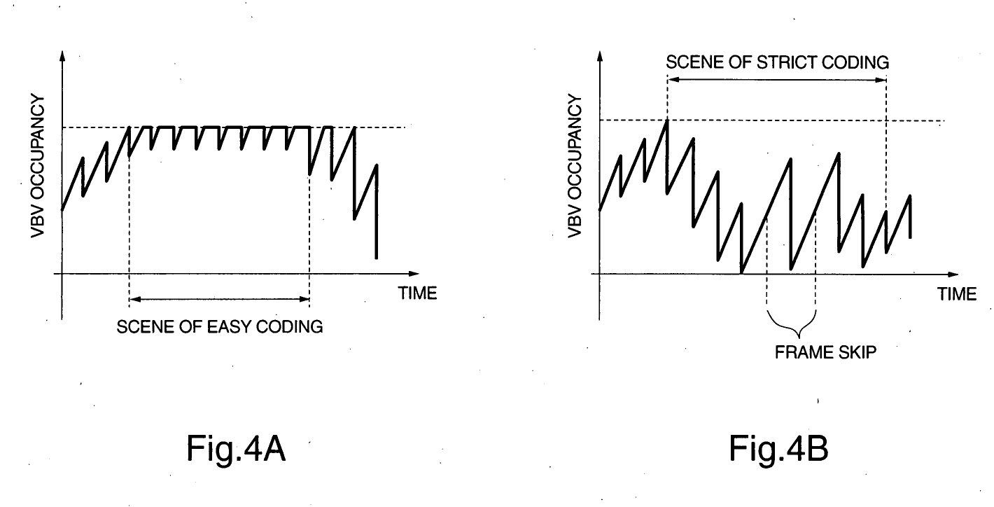

If the virtual input buffer of the VBV 102 is likely to overflow, the overflow is avoided by stopping increase of code quantity as a limit of maximum capacity of the virtual input buffer (FIG. 4A). In actual buffer, this limit corresponds to stop of code input and can be executed by general flow control. As for underflow, the skip control unit 106 avoids as explained next.

The skip control unit 106 monitors the virtual input buffer of VBV 102, and avoids underflow. Underflow and overflow are not permitted in the virtual input buffer of the VBV 102. FIG. 4B is a schematic diagram for explaining the operation of the skip control unit 106 if the virtual input buffer is likely to underflow. If a possibility of underflow of the virtual input buffer of the VBV 102 is high, the skip control unit 106 controls the coding unit 101 (Especially, the moving detector 203) to execute a frame skip. By reducing the code quantity generated from the coding unit 101 by the frame skip, the code quantity used for decoding also decreases, and the code quantity stored in the virtual input buffer of the VBV 102 is likely to increase. The possibility of an underflow is high if, for example, the code quantity stored is below a threshold, or the code quantity necessary for decoding a frame is not stored.

If the code generated by the coding unit 101 is input to the virtual decoding apparatus at the target bit rate, the virtual VBV 103 calculates code quantity predicted to be stored in the input buffer (virtual input buffer) of the virtual decoding apparatus and calculates the change rate of the code quantity. The target bit rate is a target value of average bit rate in the case of coding the moving image by the coding unit 101. For example, the target value is indicated by a user of the moving image coding apparatus. In the same way as the VBV 102, the virtual VBV 103 calculates time transition except for bit rate. Preferably, the virtual VBV 103 also does not actually execute decoding, and does not actually execute buffering. The virtual VBV 103 calculates time transition of code quantity to be stored in the virtual input buffer.

FIG. 3B is a block diagram of the virtual VBV 103 according to the present embodiment. The virtual VBV 103 includes a counter 312 storing code quantity to be stored in the virtual input buffer, a hysteresis memory unit 313 storing a value of the code quantities of a predetermined timing of predetermined period in the past, a control unit 311 increasing/decreasing the counter 312 and calculating the change rate of the code quantity, and a change rate memory unit 314 storing the change rate. The code quantity stored in the virtual input buffer of the virtual VBV 103 changes as follows.

(1) The code quantity increases in a predetermined time by a speed of the target bit rate.

(2) The code quantity decreases as a quantity to be used for decoding processing every predetermined time.

(3) Hereafter, (1) and (2) are repeated.

As the quantity to be used for decoding processing, code quantity generated for each frame by the coding unit 101 is used.

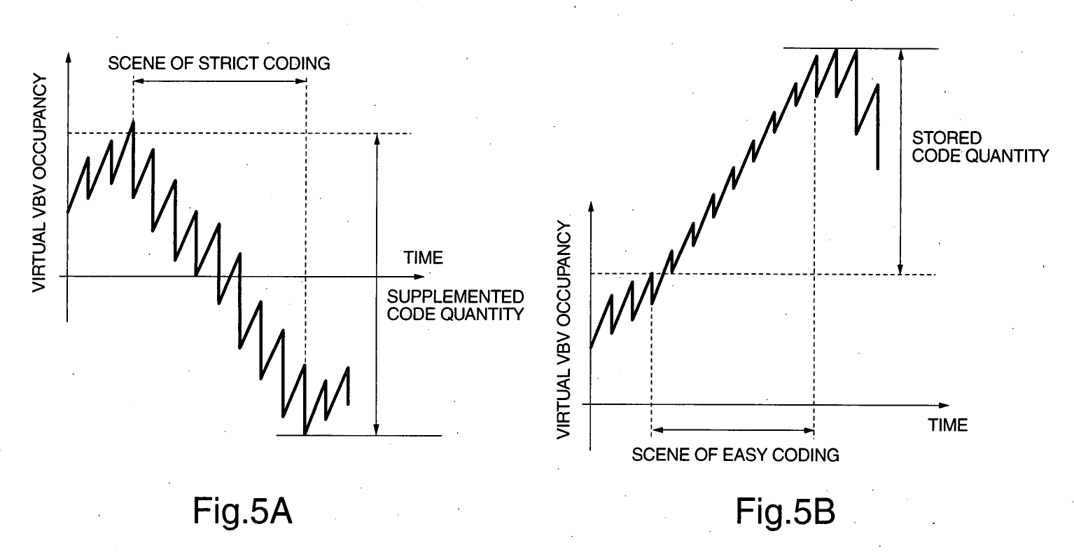

The virtual VBV 103 calculates the change rate of the code quantity using the code quantities of the past predetermined period stored in the hysteresis memory unit 313. For example, the hysteresis memory unit 313 stores the code quantity of the past one second at timing after decreasing at above (2). Different from the virtual input buffer of VBV 102, the virtual input buffer of the virtual VBV 103 permits overflow and underflow in a fixed range. FIG. 5A is a schematic diagram for explaining the status of underflow in the virtual VBV 103. FIG. 5B is a schematic diagram for explaining the status of overflow in the virtual VBV 103.

The quantization scale range control unit 104 determines a range (upper limit value, lower limit value) in which a value of the quantization scale Qp is changed by the rate control unit 105. The quantization scale range control unit 104 determines the upper limit value (upper limit Qp) and the lower limit value (lower limit Qp) of the quantization scale Qp based on the code quantity of the virtual input buffer of the VBV 102 and the code quantity and the change rate (increase rate, decrease rate) of the virtual input buffer of the virtual VBV 103.

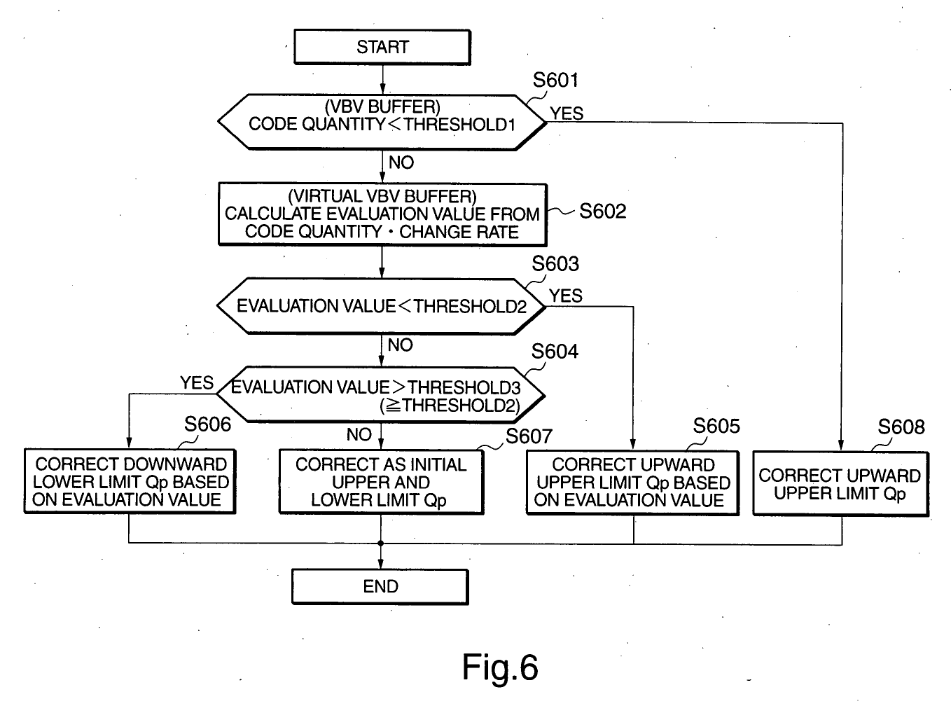

Control processing of the upper limit and the lower limit of the quantization scale is explained by referring to FIG. 6. Underflow should not occur in the VBV 102. Accordingly, the code quantity of the virtual input buffer of the VBV 102 is checked (S601). If the code quantity is below a threshold 1 (predetermined caution level of underflow), a value of the upper limit Qp is enlarged (S608). Next, an evaluation value is calculated using the code quantity and the change rate of the virtual input buffer of the virtual VBV 103 as follows.

S=α·(C−Cₘₐₓ)·|C−Cₘₐₓ|+β·V

S: evaluation value

C: code quantity

V: change rate

Cₘₐₓ: maximum capacity of virtual input buffer of the virtual VBV 103 (If the code quantity is above this value, the virtual input buffer is under a status of overflow.)

α, β: weight coefficients

The evaluation value is compared with each threshold (S603, S604), and the upper-limit Qp and the lower limit Qp are corrected based on the comparison result.

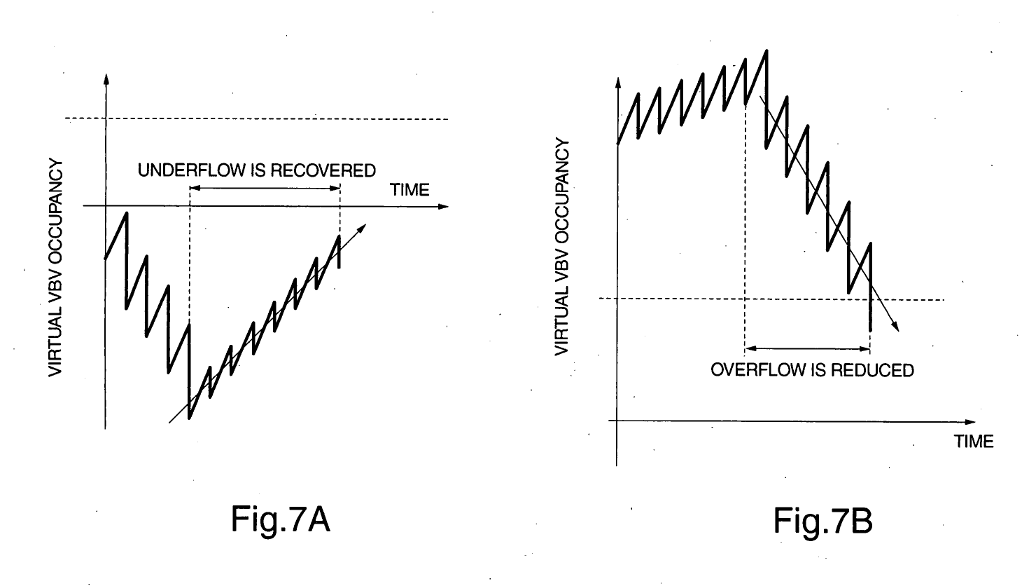

(1) If the evaluation value is below a threshold 2, the virtual input buffer of the virtual VBV 103 is under a status of underflow or suddenly decreasing because of a scene of difficult coding. In this case, the upper limit Qp is corrected upward so that the upper limit Qp becomes high in proportion to a value of (threshold 2—evaluation value) (S605). The upper limit Qp is corrected within a range below the maximum value of the quantization scale Qp. In the case that the virtual input buffer of the virtual VBV 103 is under a status of underflow, underflow of the code quantity is recovered as shown in FIG. 7A.

(2) If the evaluation value is below a threshold 3 (The threshold 3 is not below the threshold 2), the virtual input buffer of the virtual VBV 103 is under a status of overflow or suddenly increasing because of a scene of easy coding. In this case, the lower limit Qp is corrected downward so that the lower limit Qp becomes low in proportion to a value of (evaluation value—threshold 3) (S606). The lower limit Qp is corrected within a range above the minimum value of the quantization scale Qp. In the case that the virtual input buffer of the virtual VBV 103 is under a status of overflow, overflow of the code quantity is reduced as shown in FIG. 7B.

(3) In the case except for above (1) and (2), briefly, if the evaluation value S is not below the threshold 2 and not above the threshold 3, the upper limit Qp and the lower limit Qp are corrected as the initial upper and lower limit Qp (S607).

In the above control processing, the range of the quantization scale Qp is not over corrected because of a slight overflow and underflow. Furthermore, the change rate of code quantity stored in the virtual buffer of the virtual VBV 103 is taken into consideration. Accordingly, even if a scene of easy coding occurs during underflow of the virtual VBV 103, the image quality becomes stable because the quantization scale is not highly maintained above necessity. Furthermore, even if a scene of strict coding occurs during overflow of the virtual VBV 103, the image quality becomes stable because the quantization scale is not lowly maintained above necessity.

The rate control unit 105 controls a coding bit rate by changing a value of the quantization scale Qp. The rate control unit 105 calculates a target code quantity of each GOP using the code quantity and the change rate of the virtual input buffer of the virtual VBV 103. The target code quantity of GOP is determined as follows.

(1) By assuming that coding is executed by fixed target bit rate, code quantity (basis code quantity) of GOP is calculated. As for the first GOP, the basis code quantity is set as the target code quantity.

(2) A difference is calculated by subtracting the actual generated code quantity from the target code quantity.

(3) The target code quantity of next GOP is calculated by adding the basis target quantity to the difference.

(4) Hereafter, by repeating above (2) and (3), the target code quantity of each GOP is determined.

A value of the quantization scale Qp suitable for the target code quantity of GOP is determined within a range between the upper limit Qp and the lower limit Qp determined by the quantization scale range control unit 104.

In the case of large target code quantity, by setting a value of the quantization scale Qp as a small value, the code quantity generated from the coding unit 101 increases. Conversely, in the case of small target code quantity, by setting a value of the quantization scale Qp as a large value, the code quantity generated from the coding unit 101 decreases.

As mentioned-above, in the moving image coding apparatus of the present invention, the coding is executed by variable bit rate. Accordingly, while a scene of easy coding is coded by a small code quantity, a larger code quantity is assigned to a scene of strict coding.

In this case, the larger the difference between the target bit rate and the peak bit rate is, the more stable the image quality is. For example, if code data for memory medium of high speed data readable such as DVD is generated from the moving image coding apparatus of the present invention, image quality is greatly stable.

In the present embodiment, MPEG-4 is explained as an example. However, the present invention can be applied to moving image coding method such as MPEG-1, MPEG-2, and H.264. In the case of MPEG-1 and MPEG-2, the skip control unit 106 controls coding skip of a macro block of a frame to be coded.

Furthermore, in the present embodiment, a limit of underflow and overflow of the virtual VBV 103 is not set. However, the limit may be set. As one example of the limit, a lower limit is set for underflow. If the code quantity is below the lower limit, for example, the upper limit Qp is set as the maximum value in order to recover the code quantity of the virtual input buffer of the virtual VBV 103. Furthermore, as another example of limit, an upper limit may be set for overflow. If the code quantity of the virtual VBV is above the upper limit, for example, by lowering the lower limit Qp, the code quantity generated from the coding unit 101 increases and the image quality becomes fine.

For embodiments of the present invention, the processing of the present invention can be accomplished by a computer-executable program, and this program can be realized in a computer-readable memory device.

In embodiments of the present invention, the memory device, such as a magnetic disk, a floppy disk, a hard disk, an optical disk (CD-ROM, CD-R, DVD, and so on), an optical magnetic disk (MD and so on) can be used to store instructions for causing a processor or a computer to perform the processes described above.

Furthermore, based on an indication of the program installed from the memory device to the computer, OS (operation system) operating on the computer, or MW (middle ware software), such as database management software or network, may execute one part of each processing to realize the embodiments.

Furthermore, the memory device is not limited to a device independent from the computer. By downloading a program transmitted through a LAN or the Internet, a memory device in which the program is stored is included. Furthermore, the storage devices may be combined into one memory, or more than one memory may be used. In the case that the processing of the embodiments is executed by a plurality of memory devices, a plurality of memory devices may be included in the memory device. The component of the device may be arbitrarily composed.

In embodiments of the present invention, the computer executes each processing stage of the embodiments according to the program stored in the memory device. The computer may be one apparatus such as a personal computer or a system in which a plurality of processing apparatuses are connected through a network. Furthermore, in the present invention, the computer is not limited to a personal computer. Those skilled in the art will appreciate that a computer includes a processing unit in an information processor, a microcomputer, and so on. In short, the equipment and the apparatus that can execute the functions in embodiments of the present invention using the program are generally called the computer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. An apparatus for coding a moving image, comprising:
a coding unit configured to generate a code of each frame of the moving image;
a first verification unit configured to calculate a first code quantity predicted to be stored in a buffer if the code were to be supplied to the buffer in a virtual decoding apparatus by a first bit rate;
a second verification unit configured to calculate a second code quantity predicted to be stored in the buffer and a change rate of the second code quantity if the code were to be supplied to the buffer in the virtual decoding apparatus by a second bit rate lower than the first bit rate; and
a control unit configured to change a coding bit rate of said coding unit based on the first code quantity, the second code quantity, and the change rate.

2. The apparatus according to claim 1,
wherein said control unit controls said coding unit not to code all or a part of one frame if the first code quantity satisfies a predetermined condition.

3. The apparatus according to claim 2,
wherein the predetermined condition is that a possibility of underflow of the buffer is high based on the first code quantity, and
wherein the one frame is a next frame to the present frame from which the code is generated.

4. The apparatus according to claim 1,
wherein the first bit rate is the highest value of input bit rate to the buffer of the virtual decoding apparatus.

5. The apparatus according to claim 1,
wherein the second bit rate is a target value of average bit rate of the code generated from said coding unit.

6. The apparatus according to claim 1,
wherein said coding unit executes compression coding with quantization.

7. The apparatus according to claim 6,
wherein said control unit calculates a code quantity to be assigned to one or a plurality of frames based on the second code quantity and the change rate, determines an upper limit and a lower limit of a quantization scale as a parameter of a coding level based on the first code quantity, the second code quantity and the change rate, and changes the quantization scale of said coding unit based on the code quantity, the upper limit and the lower limit.

8. The apparatus according to claim 7,
wherein said control unit corrects the upper limit upward if the first code quantity is below a first threshold, calculates an evaluation value based on the second code quantity and the change rate, corrects the upper limit based on the evaluation value if the evaluation value is below a second threshold, and corrects the lower limit based on the evaluation value if the evaluation value is above a third threshold.

9. The apparatus according to claim 7,
wherein said control unit changes the quantization scale so that the second code quantity is above the lower limit of the second code quantity.

10. The apparatus according to claim 9,
wherein said control unit changes the lower limit of the second code quantity.

11. A method for coding a moving image, comprising:
generating a code of each frame of the moving image;
calculating a first code quantity predicted to be stored in a buffer if the code were to be supplied to the buffer in a virtual decoding apparatus by a first bit rate;
calculating a second code quantity predicted to be stored in the buffer and a change rate of the second code quantity if the code were to be supplied to the buffer in the virtual decoding apparatus by a second bit rate lower than the first bit rate; and
changing a coding bit rate of the code generation based on the first code quantity, the second code quantity, and the change rate.

12. The method according to claim 11, further comprising:
controlling the code generation not to code all or a part of one frame if the first code quantity satisfies a predetermined condition.

13. The method according to claim 12,
wherein the predetermined condition is that a possibility of underflow of the buffer is high based on the first code quantity, and
wherein the one frame is a next frame to the present frame from which the code is generated.

14. The method according to claim 11,
wherein the first bit rate is the highest value of input bit rate to the buffer of the virtual decoding apparatus.

15. The method according to claim 14,
wherein the second bit rate is a target value of average bit rate of the code generated.

16. The method according to claim 11, further comprising:
executing compression coding with quantization for generation of the code;
calculating a code quantity to be assigned to one or a plurality of frames based on the second code quantity and the change rate;
determining an upper limit and a lower limit of a quantization scale as a parameter of a coding level based on the first code quantity, the second code quantity, and the change rate; and
changing the quantization scale of generation of the code based on the code quantity, the upper limit and the lower limit.

17. The method according to claim 16, further comprising:
correcting the upper limit upward if the first code quantity is below a first threshold;
calculating an evaluation value based on the second code quantity and the change rate;
correcting the upper limit based on the evaluation value if the evaluation value is below a second threshold; and
correcting the lower limit based on the evaluation value if the evaluation value is above a third threshold.

18. The method according to claim 16, further comprising:
changing the quantization scale so that the second code quantity is above the lower limit of the second code quantity.

19. The method according to claim 18, further comprising:
changing the lower limit of the second code quantity.

20. A computer program product, comprising:
a computer readable program code embodied in said product for causing a computer to code a moving image, said computer readable program code comprising:
a first program code to generate a code of each frame of the moving image;
a second program code to calculate a first code quantity predicted to be stored in a buffer if the code were to be supplied to the buffer in a virtual decoding apparatus by a first bit rate;
a third program code to calculate a second code quantity predicted to be stored in the buffer and a change rate of the second code quantity if the code were to be supplied to the buffer in the virtual decoding apparatus by a second bit rate lower than the first bit rate; and
a fourth program code to change a coding bit rate of the code generation based on the first code quantity, the second code quantity, and the change rate.
